(19) United States
(12) Patent Application Publication
(10) Pub. No.: US 2025/0286039 A1
(43) Pub. Date: Sep. 11, 2025

(54) METHOD FOR ENHANCING THE DURABILITY OF ELECTROCHEMICAL DEVICES

(71) Applicant: National Taiwan University of Science and Technology, Taipei (TW)

(72) Inventors: Bing-Joe Hwang, Taipei (TW); Kassie Nigus Shitaw, Taipei (TW); Sheng-Chiang Yang, Taipei (TW); Wei-Nien Su, Taipei (TW); Teshager Mekonnen Tekaligne, Taipei (TW)

(21) Appl. No.: 19/069,760

(22) Filed: Mar. 4, 2025

Related U.S. Application Data
(60) Provisional application No. 63/562,434, filed on Mar. 7, 2024.

(51) Int. Cl. H01M 4/04; H01M 4/02; H01M 4/62; H01M 4/66; H01M 10/0525; H01M 10/0567; H01M 10/0569; H01M 50/119

(52) U.S. Cl. CPC H01M 4/0447; H01M 4/62; H01M 4/661; H01M 10/0525; H01M 10/0567; H01M 10/0569; H01M 50/119; H01M 2004/028

(57) ABSTRACT

The present invention provides a method involving with adding a metal phthalocyanine compound to a cathode material and/or electrolyte of an electrochemical device. After at least a full life cycle of the electrochemical device, the metal phthalocyanine compound is converted into a transition metal phthalocyanine compound derived from the cathode material. This process results in the formation of a beneficial cathodic electrolyte interface on the surface of the cathode material and/or the surface of the device. The formation of CEI prevents transition metal ions from migrating to the anode, which could otherwise affect the formation of the solid electrolyte interphase (SEI) on the anode surface, thereby enhancing the durability of the electrochemical device.

### FIELD OF INVENTION

The present invention is related to a method for enhancing the durability of an electrochemical device, particularly to a method of introducing an additive to enhance the durability of the electrochemical device.

The present invention has been developed primarily to be a a method of introducing an additive to enhance the durability of the electrochemical device, especially to lithium battery for describing hereinafter with references and multiple embodiments to this application. However, it will be appreciated that the present invention is not limited to this particular method, field of use or effect.

### BACKGROUND OF THE INVENTION

In an electrochemical device, electrode materials containing metal components, particularly those containing transition metal components, as well as device casings made primarily of metals such as stainless steel, titanium (Ti), vanadium (V), chromium (Cr), manganese (Mn), iron (Fe), cobalt (Co), nickel (Ni), copper (Cu), zinc (Zn), aluminum (Al), and molybdenum (Mo), may dissolve metal ions into the electrolyte during life cycles due to contact with the electrolyte. This not only damages the electrode surface structure and prevents the formation of a stable cathodic electrolyte interface (CEI) but also allows transition metal ions to migrate through the separator to the anode, leading to the degradation of the solid electrolyte interphase (SEI) on the anode surface. As a result, the durability of the electrochemical device decayed. Hence, it is eager to have a solution that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve the issues in the conventional electrochemical devices, where metal ions dissolve into the electrolyte, leading to the deterioration of the electrode surface structure, the inability to form a stable cathodic electrolyte interface (CEI), and the migration of transition metal ions through the separator to the anode in resulting in the degradation of the solid electrolyte interphase (SEI) on the anode surface and the subsequent decline in the durability of the electrochemical device, the present invention provides a method for enhancing the durability of an electrochemical device comprising steps of: providing an electrochemical device, which includes at least a cathode, an anode, and a separator disposed therebetween, enclosed within an electrochemical device casing or packaging; wherein an electrolyte is disposed between the cathode and the anode, and the electrolyte comprises an electrolyte additive; the cathode material and/or the electrolyte additive comprises a dihydrogen phthalocyanine compound and/or a metal phthalocyanine compound capable of chelating metal ions; and charging and discharging the electrochemical device, allowing the dihydrogen phthalocyanine compound and/or the metal phthalocyanine compound to react with the transition metal in the cathode material to form a transition metal phthalocyanine compound.

In accordance, the present invention has the following advantages:

The present invention introduces a metal phthalocyanine compound to the electrolyte of an electrochemical device. After the electrochemical device undergoes life cycles, the metal phthalocyanine compound is converted into a transition metal phthalocyanine compound derived from the cathode material. This process leads to the formation of a beneficial cathodic electrolyte interface (CEI) on the surface of the cathode material and/or the device surface, preventing transition metal ions from migrating to the anode, which could otherwise affect the formation of the solid electrolyte interphase (SEI) on the anode surface. Consequently, the durability of the electrochemical device is able to be enhanced significantly.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a schematic flowchart illustrating the process steps of a method for enhancing the durability of an electrochemical device in accordance to the present invention.

FIG. 2 is a schematic diagram illustrating the conversion of dilithium phthalocyanine into a transition metal phthalocyanine compound containing the cathode material in a preferred embodiment of the present invention.

FIGS. 3A and 3B respectively show X-ray photoelectron spectroscopy (XPS) spectra at the cathode after 100 charge-discharge cycles for a comparative example without dilithium phthalocyanine and embodiment 1 of the present invention in a pouch cell.

FIGS. 3C and 3D respectively show X-ray photoelectron spectroscopy (XPS) spectra at the anode after 100 charge-discharge cycles for a comparative example without dilithium phthalocyanine and embodiment 1 of the present invention in a pouch cell.

FIGS. 4A and 4B respectively show scanning electron microscope (SEM) images on the left and energy-dispersive X-ray spectroscopy (EDX) elemental analysis on the right of the anode after charge-discharge cycling for a comparative example without dilithium phthalocyanine and embodiment 1 of the present invention.

FIG. 5A shows the scanning electron microscope (SEM) image of the aluminum cathode (Al Cathode) after charge-discharge cycling for a comparative example without dilithium phthalocyanine and embodiment 1 of the present invention.

FIG. 5B shows the energy-dispersive X-ray spectroscopy (EDX) elemental analysis of the aluminum cathode (Al Cathode) after charge-discharge cycling for a comparative example without dilithium phthalocyanine and embodiment 1 of the present invention.

FIG. 6A shows the scanning electron microscope (SEM) image of the aluminum cathode (Al Cathode) after 100 charge-discharge cycles for a comparative example without dilithium phthalocyanine and embodiment 1 of the present invention.

FIG. 6B shows the energy-dispersive X-ray spectroscopy (EDX) elemental analysis of the aluminum cathode (Al Cathode) after charge-discharge cycling for a comparative example without dilithium phthalocyanine and embodiment 1 of the present invention.

FIG. 7 presents the voltage, current, and time performance under different charging conditions for a comparative example without dilithium phthalocyanine and the embodiment of the present invention.

FIGS. 8A and 8B show the scanning electron microscope (SEM) images of the aluminum cathode (Al Cathode) after 100 charge-discharge cycles for a comparative example without dilithium phthalocyanine and embodiment 1 of the present invention.

FIG. 9 presents the composition analysis of the aluminum protective layer after charge-discharge cycling for a comparative example without dilithium phthalocyanine and embodiment 1 of the present invention.

FIGS. 10A, 10B, and 10C respectively show the voltage-capacitance graphs at different charge-discharge cycles for the comparative example and embodiments 1 and 2.

FIG. 11 presents the discharge capacitance values and Coulombic efficiency at different charge-discharge cycles for the comparative example and embodiments 1 and 2.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

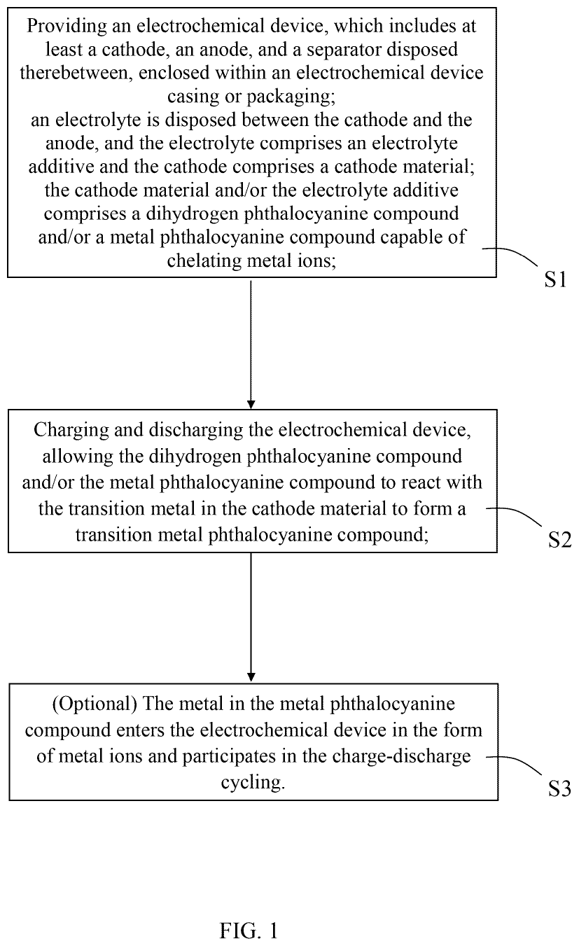

With reference to FIG. 1, which is a schematic flowchart illustrating the process steps of a method for enhancing the durability of an electrochemical device according to the present invention. The method includes the following steps:
Step S1: Providing an electrochemical device, which includes at least a cathode, an anode, and a separator disposed therebetween, enclosed within an electrochemical device casing or packaging. An electrolyte is provided between the cathode and the anode, wherein the cathode comprises a cathode material containing a transition metal. The electrolyte includes an electrolyte additive, and the cathode material and/or the electrolyte additive contains a phthalocyanine compound, such as a dihydrogen phthalocyanine compound or a metal phthalocyanine compound, in an amount ranging from 0.01 wt % to 99.99 wt %.
Step S2: Charging and discharging the electrochemical device, thereby allowing the phthalocyanine compound to react with the transition metal in the cathode material to form a transition metal phthalocyanine compound.
Step S3 (optional): If the phthalocyanine compound is a metal phthalocyanine compound, the metal in the metal phthalocyanine compound enters the electrochemical device in the form of metal ions and participates in the charge-discharge cycling.

The casing of the electrochemical battery comprises a stainless steel housing. The cathode and/or the anode includes a current collector, which may be composed of copper foil, aluminum foil, nickel foil, titanium foil, gold foil, or platinum foil.

The transition metal in the cathode material containing the transition metal comprises titanium (Ti), vanadium (V), chromium (Cr), manganese (Mn), iron (Fe), cobalt (Co), nickel (Ni), copper (Cu), or zinc (Zn). The metal in the metal phthalocyanine compound comprises lithium, sodium, potassium, magnesium, calcium, zinc, copper, iron, or aluminum. The metal phthalocyanine compound includes dilithium phthalocyanine, disodium phthalocyanine, dipotassium phthalocyanine, magnesium phthalocyanine, calcium phthalocyanine, zinc phthalocyanine, copper phthalocyanine, iron phthalocyanine, or aluminum phthalocyanine.

### EMBODIMENTS

In a preferred embodiment of the present invention, the electrochemical device is a pouch lithium battery (Pouch Cell). The cathode material comprises a ternary cathode material (NMC811). The electrolyte includes ether- or ester-based electrolytes, and in this embodiment, 1.5M LiFSI in DME/TTE (2:3 v/v) is used. The electrolyte additive includes dilithium phthalocyanine. It should be noted that this embodiment is an exemplary presentation of the cathode, anode, and electrolyte materials used; however, the cathode, anode, and electrolyte may include any suitable materials used in existing electrochemical metal or ion batteries. This invention is not limited to these specific materials, and experimental validation confirms that the claimed effects of the invention are achieved.

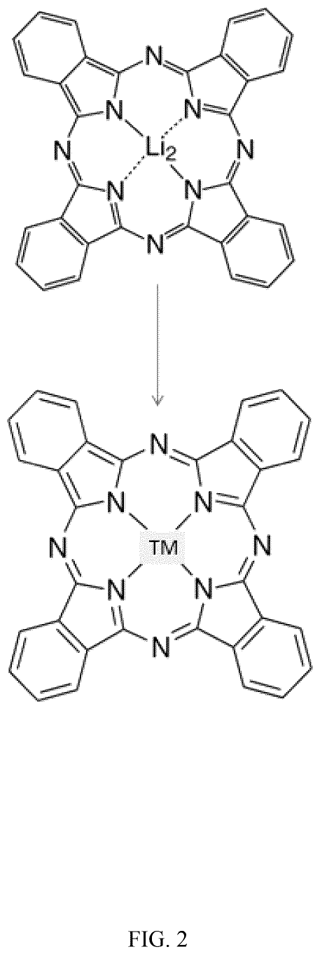

In steps S2 and S3, the dilithium phthalocyanine is converted into a transition metal phthalocyanine compound containing the cathode material, as shown in FIG. 2, including iron phthalocyanine, manganese phthalocyanine, or cobalt phthalocyanine compounds. At the same time, lithium ions are released from the dilithium phthalocyanine into the electrochemical device, participating in the charge-discharge cycling and forming an additional lithium source. The dilithium phthalocyanine in the present invention possesses lithium-ion conductivity, protecting the original transition metal-containing cathode material by forming a beneficial cathodic electrolyte interface (CEI), preventing transition metals from migrating through the separator to the anode, thereby mitigating the degradation of the solid electrolyte interphase (SEI) on the anode surface and improving the durability of the electrochemical device.

In addition to pouch batteries, the present invention can also be applied to electrochemical devices with stainless steel casings. In these devices, not only does dilithium phthalocyanine convert into a transition metal phthalocyanine compound containing the cathode material, but the formation of transition metal phthalocyanine compounds also prevents transition metals from corroding or eroding the internal surface of the stainless steel casing, thereby further enhancing the durability of electrochemical devices with stainless steel casings.

### <Verification Tests>

Please refer to Table 1, which compares a comparison example (without dilithium phthalocyanine) with Embodiment 1, where 0.2 wt % dilithium phthalocyanine is added to the electrolyte, and Embodiment 2, where 0.2 wt % dilithium phthalocyanine is added to the cathode material. In these tests, a pouch lithium battery (Pouch Cell) using NMC811 as the cathode material and 1.5M LiFSI in DME/TTE (2:3 v/v) as the electrolyte was used.

TABLE 1

| | Type of | | |
|---|---|---|---|
| | Electrochemical | | |
| Samples | Device | Electrolyte | Additive |
| Comparison | NMC811/Cu pouch | 1.5M LiFSI, | Without (w/o) |
| example | battery, Al/Li | DME/TTE (2:3 | |
| | | v/v) | |
| Embodiment 1 | NMC811/Cu pouch | 1.5M LiFSI, | 0.2 wt % |
| | battery, Al/Li | DME/TTE (2:3 | Dilithium |
| | | v/v) | Phthalocyanine in |
| | | | Electrolyte |
| Embodiment 2 | NMC811/Cu pouch | 1.5M LiFSI, | 0.2 wt % |
| | battery, Al/Li | DME/TTE (2:3 | Dilithium |
| | | v/v) | Phthalocyanine in |
| | | | Cathode Material |
| Embodiment 3 | NMC811/Cu pouch | 1.5M LiFSI, | 0.2 wt % |
| | battery, Al/Li | DME/TTE (2:3 | Dihydrogen |
| | | v/v) | Phthalocyanine in |
| | | | Cathode Material |

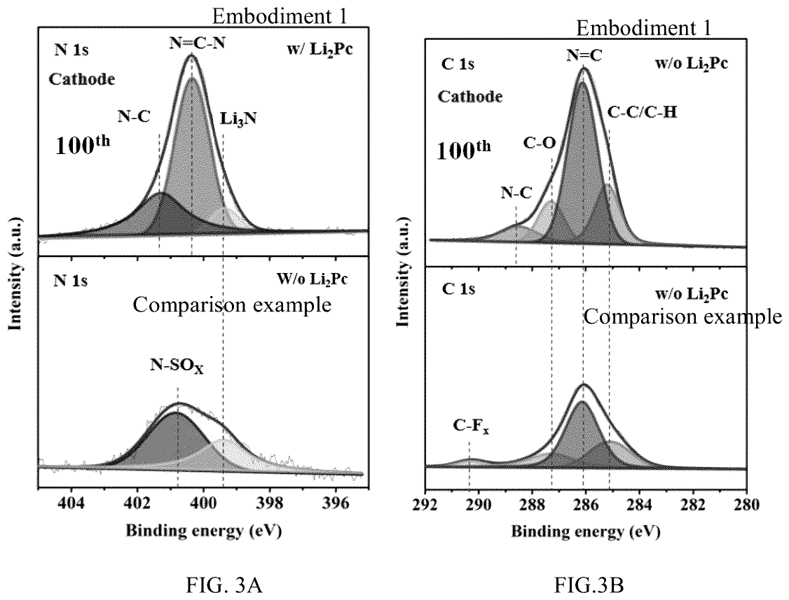

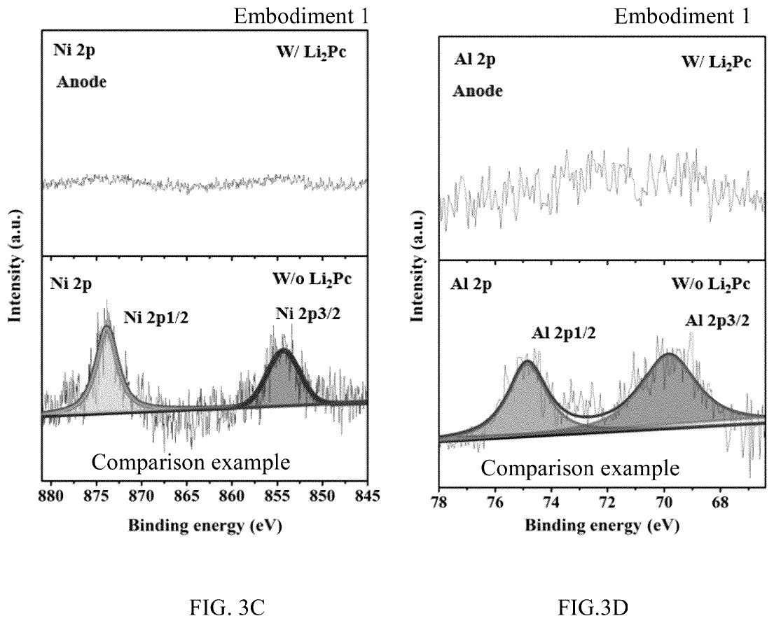

Please refer to FIGS. 3A and 3B, which show the X-ray photoelectron spectroscopy (XPS) spectra at the cathode after 100 charge-discharge cycles for a comparison example without dilithium phthalocyanine and Embodiment 1 of the present invention. The nitrogen and carbon source analysis reveals that the cathode in Embodiment 1 contains nitrogen and carbon signals from dilithium phthalocyanine, indicating that dilithium phthalocyanine remains on the cathode after multiple charge-discharge cycles, whereas the control only shows signals from LiFSI-derived sulfur and fluorine.

Please refer to FIGS. 3C and 3D, which show the XPS spectra at the anode after 100 charge-discharge cycles for the comparison example and Embodiment 1. The analysis shows that the control exhibits strong transition metal signals (Ni, Al) on the anode, while Embodiment 1 shows no detectable transition metal signals, demonstrating that dilithium phthalocyanine effectively prevents transition metal migration to the anode.

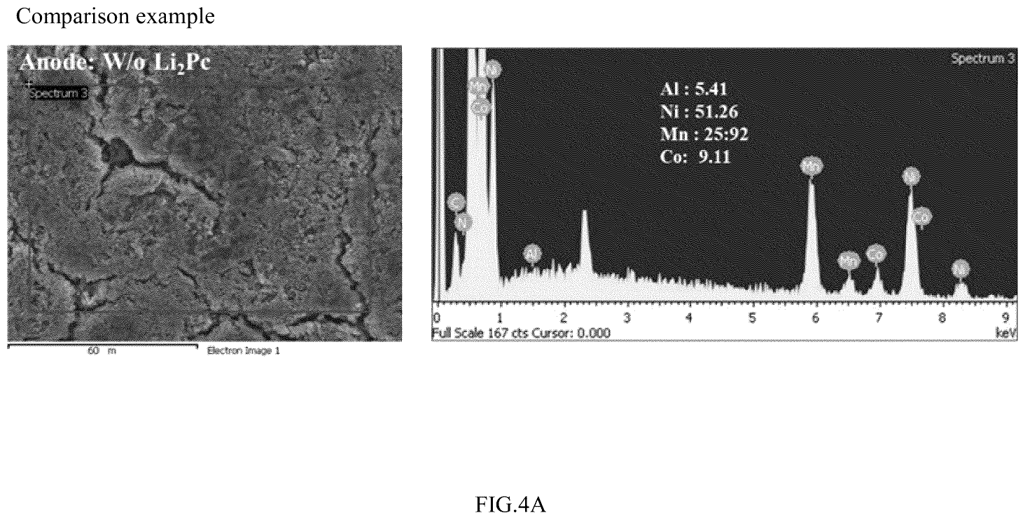

Please refer to FIGS. 4A and 4B, which show scanning electron microscope (SEM) images on the left and energy-dispersive X-ray spectroscopy (EDX) elemental analysis on the right for the comparison example (without dilithium phthalocyanine) and Embodiment 1 of the present invention after charge-discharge cycling. FIG. 4A shows that the comparison example exhibits significant signals of transition metals (nickel, manganese, cobalt) from the cathode appearing at the anode, whereas in Embodiment 1, the signals of these transition metals are significantly weaker. This indicates that the addition of dilithium phthalocyanine in the present invention effectively suppresses the shuttle effect of transition metals from the cathode to the anode.

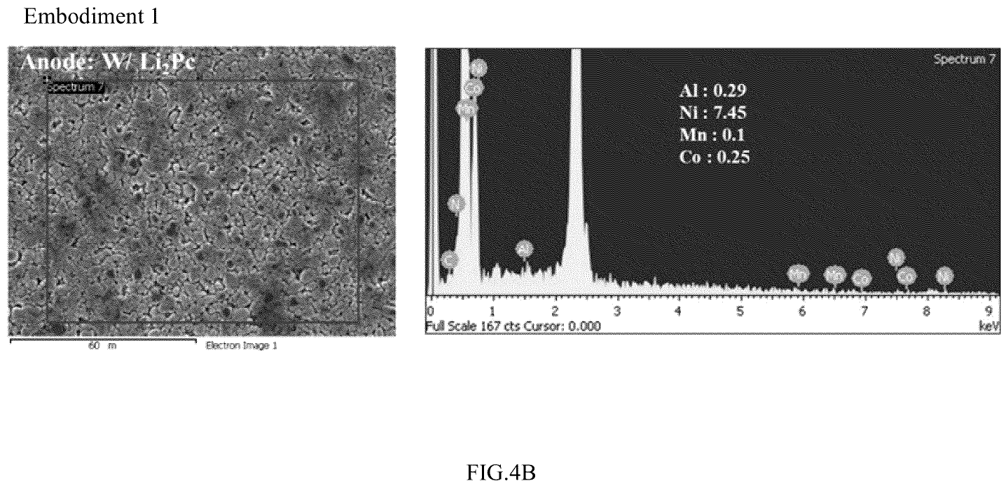

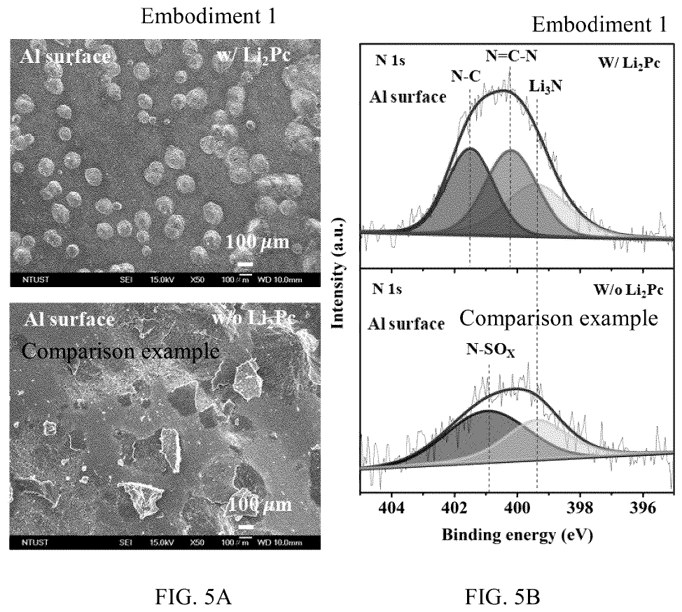

Please refer to FIG. 5A, which shows scanning electron microscope (SEM) images of the aluminum cathode (Al Cathode) after charge-discharge cycling for both the comparison example and Embodiment 1. FIG. 5B presents the energy-dispersive X-ray spectroscopy (EDX) elemental analysis of the aluminum cathode after charge-discharge cycling for both the comparison example and Embodiment 1. FIGS. 5A and 5B indicate that in Embodiment 1, transition metal phthalocyanine compound particles derived from dilithium phthalocyanine are formed on the aluminum cathode surface, whereas the comparison example shows signs of corrosion on the aluminum cathode surface. Additionally, FIG. 5B shows that the aluminum cathode in Embodiment 1 exhibits nitrogen-carbon functional groups from the phthalocyanine compound, whereas the control only presents sulfur compounds from the electrolyte.

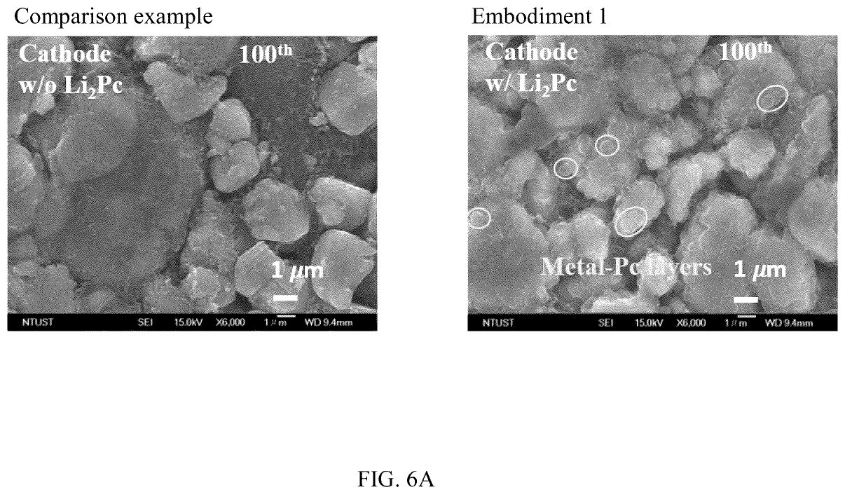

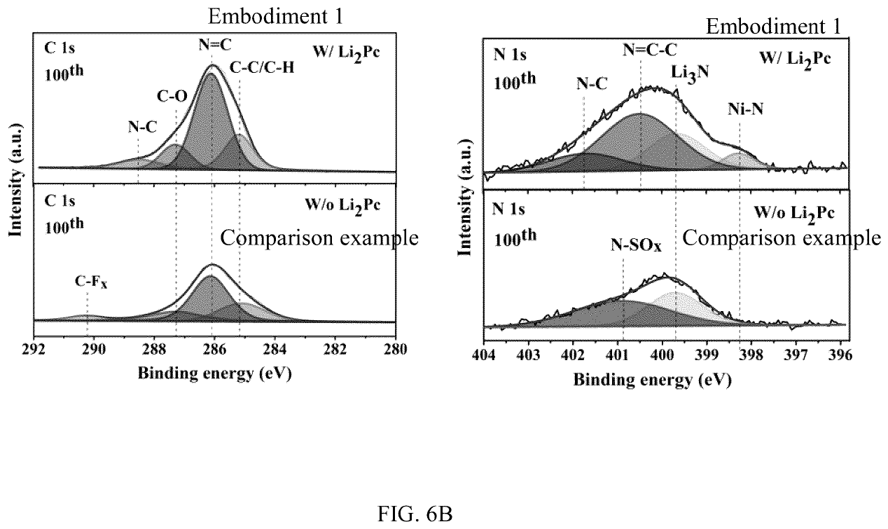

Please refer to FIGS. 6A and 6B, which show scanning electron microscope (SEM) images of the aluminum cathode (Al Cathode) after 100 charge-discharge cycles for both the comparison example and Embodiment 1. FIG. 6B presents energy-dispersive X-ray spectroscopy (EDX) elemental analysis of the aluminum cathode after charge-discharge cycling for both the comparison example and Embodiment 1. FIGS. 6A and 6B indicate that in Embodiment 1, a cathodic electrolyte interface (CEI) layer consisting of lithium nitride and nickel nitride is formed on the aluminum cathode surface. This CEI layer prevents transition metal ions from migrating to the anode, thereby improving the durability of the electrochemical device by mitigating the degradation of the solid electrolyte interphase (SEI) on the anode surface.

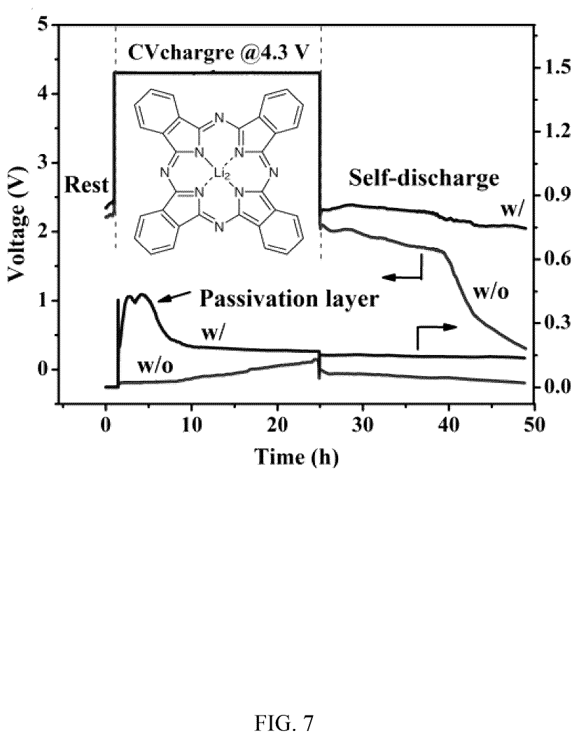

Please refer to FIG. 7, which shows the voltage, current, and time performance under different charging conditions for the comparison example and the embodiments of the present invention. Since the embodiment forms a cathodic electrolyte interface (CEI) protection layer, FIG. 7 demonstrates that when charging at a constant voltage of 4.3V for over 20 hours, the embodiment maintains better current and voltage performance during discharge, whereas the comparison example exhibits a significant performance decline or decay.

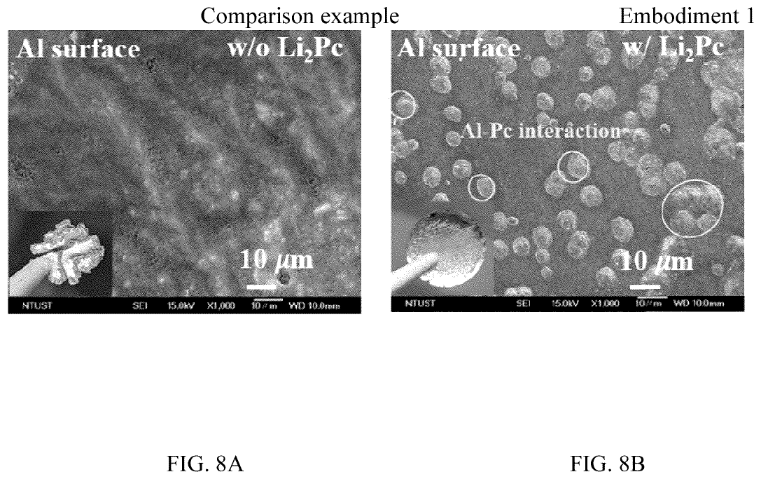

Please refer to FIGS. 8A and 8B, which show scanning electron microscope (SEM) images of the aluminum cathode (Al Cathode) after 100 charge-discharge cycles for both the comparison example and the embodiment of the present invention. The images confirm that in the embodiment, transition metal phthalocyanine compound particles are formed as a result of the reaction between aluminum and phthalocyanine, demonstrating that the addition of dilithium phthalocyanine effectively suppresses the shuttle effect of transition metals from the cathode to the anode.

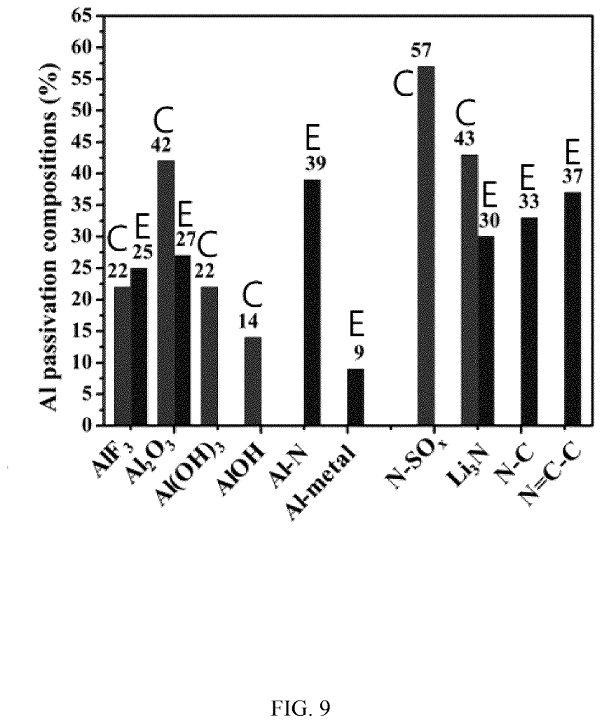

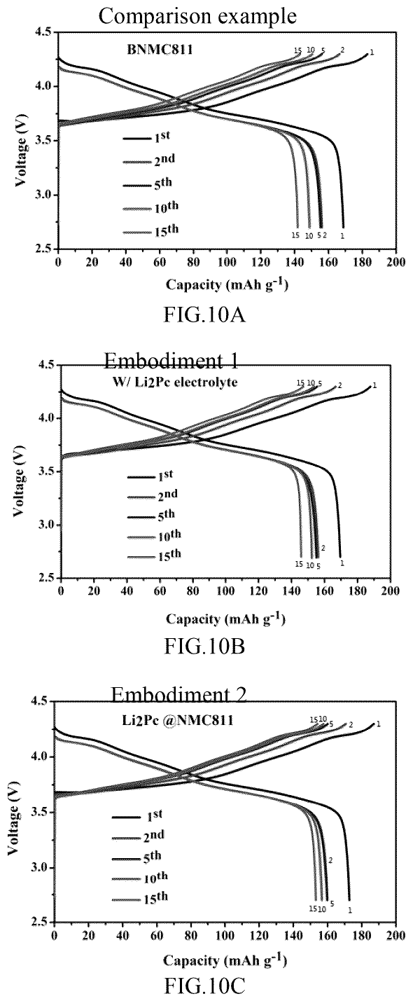

Please refer to FIG. 9, which presents the composition analysis of the aluminum protective layer after charge-discharge cycling for both the comparison example and the embodiment of the present invention. FIG. 10 further shows that only in the embodiment, transition metal phthalocyanine compounds are formed on the aluminum cathode surface due to the reaction between aluminum and phthalocyanine, whereas in the comparison example, no transition metal phthalocyanine compounds are observed.

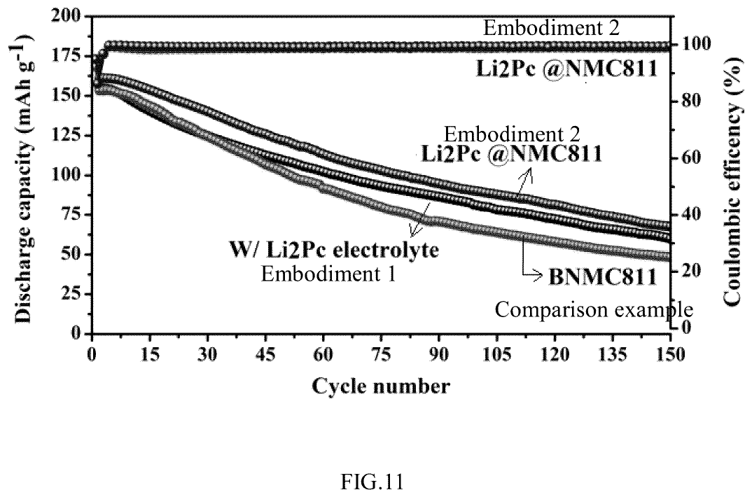

Please refer to FIGS. 10A, 10B, and 10C, which illustrate voltage-capacitance graphs at different charge-discharge cycles for the comparison example, Embodiment 1, and Embodiment 2. The data indicate that after 15 charge-discharge cycles, Embodiments 1 and 2 exhibit significantly superior capacitance performance compared to the comparison example. Please refer to FIG. 11, which presents discharge capacitance values and Coulombic efficiency at different charge-discharge cycles for the comparison example, Embodiment 1, and Embodiment 2. FIG. 11 demonstrates that Embodiments 1 and 2 exhibit better electrochemical performance compared to the comparison example.

Please refer to Table 2, which summarizes the electrochemical performance data corresponding to FIGS. 3A to 11 for both the comparison example and the embodiments of the present invention.

TABLE 2

| | Initial Coulombic | Average Coulombic | Capacity |
|---|---|---|---|
| | Efficiency | Efficiency (Avg. | Retention (CR, |
| Sample | (Int. CE, %) | CE, %)/100th Cycle | %)/100th Cycle |
| Comparative | 88.86 | 99.11 | ~42.1 |
| example | | | |
| Embodiment 1 | 88.89 | 99.28 | ~48.8 |
| Embodiment 2 | 88.91 | 99.43 | ~59.7 |

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A method for enhancing the durability of an electrochemical device, comprising the steps of:
Step S1: providing an electrochemical device, which includes at least a cathode, an anode, and a separator disposed therebetween, enclosed within an electrochemical device casing or packaging; wherein an electrolyte is disposed between the cathode and the anode, and the electrolyte comprises an electrolyte additive and the cathode comprises a cathode material;
the cathode material and/or the electrolyte additive comprises a dihydrogen phthalocyanine compound and/or a metal phthalocyanine compound capable of chelating metal ions; and
Step S2: charging and discharging the electrochemical device, allowing the dihydrogen phthalocyanine compound and/or the metal phthalocyanine compound to react with the transition metal in the cathode material to form a transition metal phthalocyanine compound.

2. The method for enhancing the durability of an electrochemical device as claimed in claim 1, wherein the metal in the dihydrogen phthalocyanine compound and/or the metal phthalocyanine compound enters the electrochemical device in the form of metal ions and participates in charge-discharge cycling.

3. The method for enhancing the durability of an electrochemical device as claimed in claim 1, wherein the cathode forms a beneficial cathodic electrolyte interface.

4. The method for enhancing the durability of an electrochemical device as claimed in claim 1, wherein the transition metal in the cathode material does not migrate through the separator to the anode during the charge-discharge process.

5. The method for enhancing the durability of an electrochemical device as claimed in claim 1, wherein the transition metal in the cathode material comprises titanium (Ti), vanadium (V), chromium (Cr), manganese (Mn), iron (Fe), cobalt (Co), nickel (Ni), copper (Cu), or zinc (Zn).

6. The method for enhancing the durability of an electrochemical device as claimed in claim 2, wherein the transition metal in the cathode material comprises titanium (Ti), vanadium (V), chromium (Cr), manganese (Mn), iron (Fe), cobalt (Co), nickel (Ni), copper (Cu), or zinc (Zn).

7. The method for enhancing the durability of an electrochemical device as claimed in claim 3, wherein the transition metal in the cathode material comprises titanium (Ti), vanadium (V), chromium (Cr), manganese (Mn), iron (Fe), cobalt (Co), nickel (Ni), copper (Cu), or zinc (Zn).

8. The method for enhancing the durability of an electrochemical device as claimed in claim 4, wherein the transition metal in the cathode material comprises titanium (Ti), vanadium (V), chromium (Cr), manganese (Mn), iron (Fe), cobalt (Co), nickel (Ni), copper (Cu), or zinc (Zn).

9. The method for enhancing the durability of an electrochemical device as claimed in claim 1, wherein the metal in the metal phthalocyanine compound comprises lithium (Li), sodium (Na), potassium (K), magnesium (Mg), calcium (Ca), zinc (Zn), copper (Cu), iron (Fe), or aluminum (Al).

10. The method for enhancing the durability of an electrochemical device as claimed in claim 2, wherein the metal in the metal phthalocyanine compound comprises lithium (Li), sodium (Na), potassium (K), magnesium (Mg), calcium (Ca), zinc (Zn), copper (Cu), iron (Fe), or aluminum (Al).

11. The method for enhancing the durability of an electrochemical device as claimed in claim 3, wherein the metal in the metal phthalocyanine compound comprises lithium (Li), sodium (Na), potassium (K), magnesium (Mg), calcium (Ca), zinc (Zn), copper (Cu), iron (Fe), or aluminum (Al).

12. The method for enhancing the durability of an electrochemical device as claimed in claim 4, wherein the metal in the metal phthalocyanine compound comprises lithium (Li), sodium (Na), potassium (K), magnesium (Mg), calcium (Ca), zinc (Zn), copper (Cu), iron (Fe), or aluminum (Al).

13. The method for enhancing the durability of an electrochemical device as claimed in claim 9, wherein the metal phthalocyanine compound comprises dilithium phthalocyanine, disodium phthalocyanine, dipotassium phthalocyanine, magnesium phthalocyanine, calcium phthalocyanine, zinc phthalocyanine, copper phthalocyanine, iron phthalocyanine, or aluminum phthalocyanine.

14. The method for enhancing the durability of an electrochemical device as claimed in claim 1, wherein the casing of the electrochemical battery comprises a stainless steel casing.

15. The method for enhancing the durability of an electrochemical device as claimed in claim 2, wherein the casing of the electrochemical battery comprises a stainless steel casing.

16. The method for enhancing the durability of an electrochemical device as claimed in claim 3, wherein the casing of the electrochemical battery comprises a stainless steel casing.

17. The method for enhancing the durability of an electrochemical device as claimed in claim 4, wherein the casing of the electrochemical battery comprises a stainless steel casing.

18. The method for enhancing the durability of an electrochemical device as claimed in claim 1, wherein the cathode and/or the anode comprises a current collector, which includes copper foil, aluminum foil, nickel foil, titanium foil, gold foil, or platinum foil.

19. The method for enhancing the durability of an electrochemical device as claimed in claim 1, wherein the electrolyte comprises an ether-based or ester-based electrolyte.
